(19) United States
(12) Patent Application Publication
(10) Pub. No.: US 2025/0014883 A1
(43) Pub. Date: Jan. 9, 2025

(54) DEPOSIT-REDUCING IONIZATION SOURCE

(71) Applicant: QUADROCORE CORP., Markham (CA)

(72) Inventors: Gholamreza Javahery, Thornhill (CA); Ramin Sharifi, Toronto (CA); Victor Titov, Etobicoke (CA); Dmitry Valyaev, Richmond Hill (CA); Fadi Jozif, North York (CA)

(21) Appl. No.: 18/896,692

(22) Filed: Sep. 25, 2024

Related U.S. Application Data
(63) Continuation-in-part of application No. PCT/CA2023/050393, filed on Mar. 23, 2023.
(60) Provisional application No. 63/323,717, filed on Mar. 25, 2022.

(51) Int. Cl. H01J 49/04

(52) U.S. Cl. CPC H01J 49/045; H01J 49/0468

(57) ABSTRACT

A deposit-reducing ionization source for sample introduction to a mass spectrometer is provided. It comprises a heated vessel with a set of circulating hot gases to avoid any condensation to be formed within the volume of the vessel, keeping the vessel clean. The vessel has a tubular cross section with a conduit attached to its side wall. The vessel is placed in front of the orifice of a curtain cone. An exhaust port is on the opposite side of the conduit on the wall and close to the curtain cone. A nebulizer is placed inside the conduit. A nebulizing gas and an auxiliary gas are introduced in the conduit and a curtain gas is introduced in the curtain cone.

### FIELD OF THE INVENTION

The present invention generally relates to atmospheric pressure ionization sources for mass spectrometry and particularly to a system to reduce contamination in the ion source and ion introduction systems.

### BACKGROUND OF THE INVENTION

Mass spectrometers (MS) are used to determine molecular weight and structural information about chemical compounds. Molecules are weighed by ionizing the molecules and measuring the response of their trajectories in a vacuum to electric and magnetic fields. Ions are weighed according to their mass-to-charge (m/z) values. Generally, a sample analysis comprises of sample introduction, ion source, ion separation, and ion detection, the most critical steps being sample introduction and ion source. The sensitivity of a mass spectrometer, in part, directly depends on the efficiency of the ion source for generating high yields of desired ions of interest.

In atmospheric pressure mass spectrometry, there are three major types of sources. Typically, primary ions are formed at atmospheric pressure by initiation of a gaseous electrical discharge by an electric field or by electrospray ionization (ESI). The primary ions in turn ionize the gas phase analyte molecules by either an ion-molecule process, as occurs in atmospheric pressure chemical ionization (APCI) by a charge transfer process, or by entraining the analyte molecules in a charged droplet of solvent produced in the electrospray process. In the case of analyte being entrained in a charged liquid droplet, the ionization process is the same as in electrospray ionization (ESI) because the analyte molecules are first entrained in the liquid droplets and subsequently ionized.

Electro-spray ionization (ESI) and atmospheric pressure chemi-ionization (APCI) are the most versatile ionization techniques in modern mass spectrometry. In both, ionization process proceeds at atmospheric or near atmospheric pressures. Atmospheric pressure photo ionization (APPi) has been also developed for ionization of certain compounds. All ionization techniques, at atmospheric pressure, have one major advantage over other techniques, which is ionization process is soft and molecules of interest ionize at their ground energy level. This is an important feature keeping integrity of the compound molecular structure intact.

In a typical atmospheric ionization, a solution is injected through a needle at high pressures. The needle diameter is typically about 0.01 mm or 0.2 mm. The high pressure injection of the polar liquid generates a plume or a mist of small droplets. This plume may contain the sample and a buffer. The buffer typically is some mixture of water or alcohol or any other material. A voltage (typically 4000-6000 V) is applied to the needle to cause charged droplets. The charged droplets undergo charged separation at the tip of the needle. Then, the plume is injected into a source housing which contains alike charged droplets. Sometimes heat is introduced to desolvate the plume and vaporize the material to change the plume into a gas phase, which will partly go to the mass spectrometer through a sample introduction orifice. In all these systems, the entire source is contained in a source housing.

In many systems, the sample introduction orifice is placed behind an aperture known as curtain cone, which is placed in the vicinity of the plume. Clean gas (curtain gas) is introduced between these two apertures to prevent unwanted species entering the mass spectrometer as well as assisting in desolvation of the sprayer plume. In the case of ESI, high voltage is applied to the emitter, therefore the polarized sample undergoes charge separation at the tip of the sprayer emitter. Depending on the polarity of the applied voltage, ions generated with opposite charge of the applied voltage at the tip of the emitter return to the emitter and neutralize. Other charge species normally are repelled by this voltage and move towards the sample introduction orifice of the MS. Sprayer plume, which is partially in the liquid phase and partially in the gas phase normally condensate on the inner wall of the ionization housing causing residue of the sample to be present. Over time, this condensation builds up and causes cross contamination and hence requires frequent cleaning to avoid cross interference with subsequent samples.

In many mass spectrometers, ESI or APCI or both are set in front of the mass spectrometer and are surrounded with a container for safety as well as preventing room air molecules from entering the container. In most cases, sprayer plume is aided with nebulizer gas and auxiliary heat provided for further desolvation of the plume. Also, the auxiliary heating is critical in a high flow of liquid chromatography (LC) to assist desolvation and hence improving sensitivity of the device.

In the current systems, the spray plume and auxiliary heating cause vaporization of the liquid containing buffers and samples. The vapor distributes into the surroundings and condensates on inner surfaces of the housing where ionization sources are located. This causes interference with detection of the sample of interest (cross contamination) and requires frequent cleaning, resulting in decreased uptime of the mass spectrometry device.

One of the major problems in modern mass spectrometry is keeping the source clean. The source must be maintained clean to operate properly. The interior surfaces of atmospheric pressure ionization sources are especially prone to such contamination, since they are routinely exposed during operation to samples of aerosols, which may frequently include non-volatile compounds. Accumulation of sample matrix components on the interior surfaces of the source can cause loss of sensitivity in MS. As noted earlier, when the plume cools, some of it may condensate around the housing of the device. This can change the properties of subsequent samples that are introduced in the system. If some of the first sample is condensed and remains inside the source housing, it will contaminate the second sample.

Conventional methods for removing contamination sources generally involve removal or disassembly of the contaminated ion source followed by manual cleaning. Subsequently, after putting the ion source back into service, the mass spectrometer may need to be recalibrated. Such manual cleaning is therefore wasteful of time and resources and, furthermore, is not practical given the rapidity with which contamination can build.

### SUMMARY OF THE INVENTION

The present invention discloses a sample introduction system which limits accumulation of any material in the ionization source and introduction regions. The system comprises of a heated vessel that is placed in front of the mass spectrometer (MS). The vessel has several gaseous flows configured to generate a set of circulation zones inside the vessel and to keep ions confined in a central region of the heated vessel. The vessel has a right side, a left side, a top side, and a bottom side. A heater is used to heat the heated vessel to prevent formation of condensations on its surfaces and keep the gases inside the vessel at high temperatures. A conduit is attached to the top side of the heated vessel. A nebulizer having a nebulizer tip is placed inside the conduit. The nebulizer tip is placed at a predefined location, either inside the conduit or penetrated into the heated vessel. A nebulizing gas, having a nebulizer gas flow rate and temperature, is used in the nebulizer to form a nebulized sample from a sample. A heated auxiliary gas, having an auxiliary flow rate and temperature, is introduced into the conduit surrounding the nebulizer and the nebulizing gas. A curtain cone, which may be part of an interface of the MS or a separate interface, is placed on the right side of the heated vessel. The curtain cone has an orifice which allows ions to flow out of the vessel and towards the MS. A heated curtain gas, having a curtain gas flow rate and temperature, is introduced into the curtain cone. The curtain gas enters into the heated vessel from the right side of the heated vessel. An exhaust port is placed on the bottom side of the vessel, closer to the right side. A pump is connected to the exhaust port to form an exhaust flow. The pump induces an exhaust flow rate out of the heated vessel. One or more ionization sources can be attached to the vessel and can be operated together or in sequence. Ionization sources are placed inside the conduit or on the right side or on the bottom side of the heated vessel to ionize the nebulized sample and form ions. The nebulizer gas flow rate and temperature, the auxiliary flow rate and temperature, the curtain gas flow rate and temperature, and the exhaust flow rate are configured to confine the ions in a central zone of the heated vessel and away from the walls of the heated vessel. These flows result in the formation of a set of circulating flows of heated gases inside the heated vessel to keep the vessel clean. An electric field inside the vessel guides the ions from the central zone towards the orifice of the curtain cone and towards the mass spectrometer.

In accordance with the invention, there is provided a deposit-reducing system for mass spectrometry, comprising: a heated vessel, to be mounted in front of a sample introduction system of a mass spectrometer (MS); a heater configured to heat the heated vessel; a conduit attached to the heated vessel; a nebulizer configured to introduce a nebulizing gas, where the nebulizing gas has a nebulizer gas flow rate and temperature; a sample introduction device having a sample introduction tip, configured to introduce a sample into the heated vessel through the sample introduction tip, wherein the sample introduction tip is placed either inside the conduit or inside the heated vessel; the nebulizer and the sample introduction device being configured so the nebulizing gas mixes with the sample at the sample introduction tip to form a mixture of nebulizer gas and the sample at the sample introduction tip; and where the nebulizer gas flow rate is at least around 0.8+/−10% mach.

In an aspect of the invention, the deposit-reducing system for mass spectrometry further comprises a heated auxiliary gas, having an auxiliary gas flow rate and temperature, introduced into the heated vessel through the conduit and configured to surround the nebulizing gas; a curtain cone, interfacing with the sample introduction system of the MS through an orifice of the sample introduction system of the MS, the curtain cone being located in the heated vessel; a heated curtain gas, having a curtain gas flow rate and temperature, introduced between the curtain cone and the orifice; the heated vessel having an exhaust port, the exhaust port being connected to a pump and the pump being configured to form an exhaust flow, having an exhaust flow rate, out of the heated vessel; a first ionization device configured to ionize the sample and form a mixture of nebulizing gas and ions; and wherein the nebulizer gas flow rate and temperature, the auxiliary flow rate and temperature, the curtain gas flow rate and temperature, and the exhaust flow rate are configured to direct the ions away from the walls of the heated vessel.

In another aspect of the invention, the deposit-reducing system for mass spectrometry has a nebulizer gas flow rate of around 1.0+/−10% mach or higher. In another aspect, the deposit-reducing system for mass spectrometry further comprises the tip of the sample introduction device having a voltage; the curtain cone having a voltage lower than the tip; and the orifice having a voltage lower than the curtain cone. In still another aspect of the invention, the deposit-reducing system for mass spectrometry further comprises the orifice having a voltage; the curtain cone having a voltage lower than the orifice; and the tip of the sample introduction device having a voltage lower than the curtain cone.

In yet another aspect of the invention, the deposit-reducing system for mass-spectrometry of further comprises the tip of the sample introduction device, the curtain cone, and the orifice having voltages to form a voltage gradient, where the system is configured to allow an operator to switch between a positive voltage gradient and a negative voltage gradient. In another aspect of the invention, the deposit-reducing system for mass spectrometry has the first ionization device being one of: (i) an electrospray device, (ii) an atmospheric pressure chemical ionization (APCI) device, or (iii) an atmospheric pressure photoionization (APPI) device. In another aspect of the invention, the deposit-reducing system for mass spectrometry has the auxiliary gas and mixture of nebulizing gas and ions move in a laminar flow.

In another aspect of the invention, the deposit-reducing system for mass spectrometry has the heated vessel being heated up to at least around 500+/−10% ° C. In another aspect of the invention, the heated vessel is tubular and the heated vessel has a cross-sectional shape selected from the group consisting of a circle, ellipse, oval and multisided shapes. In still another aspect of the invention, the heated vessel has a circular cross-sectional shape and has a diameter of around 45+/−10% mm and a length of around 75+/−10% mm. In still another aspect of the invention, the heated vessel has dimensions that fit within an envelope of dimensions of around 50+/−10% mm by around 50+/−10% mm by around 80+/−10% mm. In yet another aspect of the invention, the deposit-reducing system for mass spectrometer further comprises a second ionization device, and the first ionization device and the second ionization device are configured to operate either simultaneously or as alternatives within the heated vessel.

The present system provides a deposit-limiting ionization source and in which different ionization sources can be implement and used together or in sequence, reducing any need to remove, disassemble and manually clean the system. In addition, the present system allows use of different ionization sources, which are installed and calibrated, in sequence, without any need to recalibrate the system. The present system saves time and resources and provides more efficient operation of a mass spectrometer.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows the first embodiment of the present invention,

FIG. 2 shows the second embodiment of the present invention,

FIG. 3 shows the third embodiment of the present invention, and

FIG. 4 shows the fourth embodiment of the present invention.

### DETAILED DESCRIPTION OF THE INVENTION

Most sample introduction systems are comprised of a vessel where a spray plume is introduced and volatilized by a heated auxiliary gas. The vessel is placed close to an orifice of curtain cone to introduce ions into a mass spectrometer. The problem with such devices is that there is little control of where the sample may go while inside the vessel. Although a part of the sample flows towards the MS, some part may remain on the surfaces of the vessel and cause contamination issue in the next tests.

The present system is configured to confine the sample and the ions in a central region of a vessel and prevent them from hitting the vessel walls. This is achieved by forming a circulating flow filed inside the vessel that continuously clears material away from the vessel surfaces. In the present system, a heated vessel 200, comprised of a small hollow tube, is placed in front of the sample introduction of a MS device. The heated vessel may be tubular and may have a circular, elliptical, oval, multisided, or any other cross-sectional shape. In a preferred embodiment, the heated vessel has a circular cross-sectional shape and has a diameter of around 45 mm and a length of around 75 mm. In another embodiment, the heated vessel has a tubular shape with a circular, elliptical, oval, or multisided cross-section that fits within an envelope of dimensions of around 50 mm by around 50 mm by around 80 mm. In this paragraph, around means plus or minus 10%.

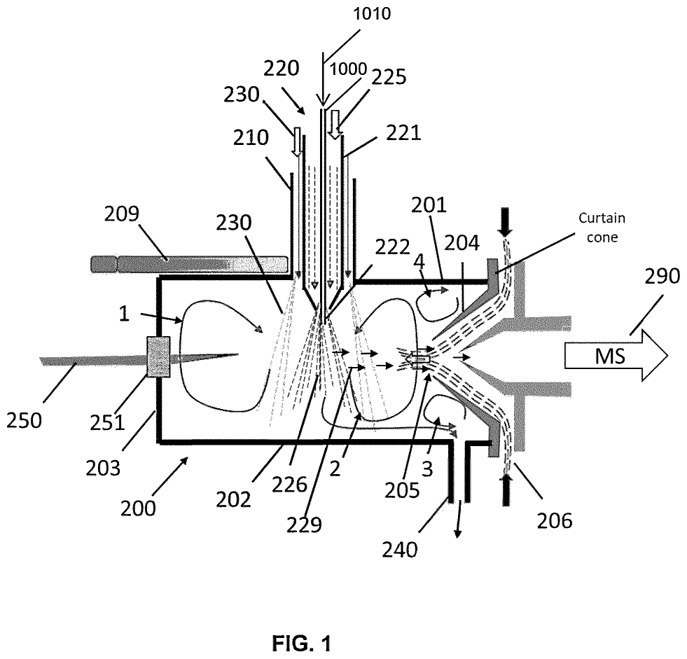

In order to describe the positioning of different systems with respect to the heated vessel, the sides of the vessel are named as the top side 201, the bottom side 202, the left side 203, and the right side 204, as illustrated in FIG. 1.

The right side 204 forms a curtain cone of the MS device 290. In other embodiments, there may be a separate curtain cone as part of a MS interface or the curtain cone may be a separate unit. The curtain cone has a sampling orifice 205 to receive ions and a curtain gas 206, which in part enters the heated vessel at sampling orifice 205.

In FIG. 1 the heated vessel has a conduit 210 that is attached to the top side of the vessel 200. The conduit is configured to receive a nebulizer 220. The nebulizer 220 has a nebulizer tube 221. Conduit 210 is also configured to receive a sample introduction tube 1000 for a sample 1010. In a preferred embodiment, the nebulizer 220 is configured to include a sample introduction tube 1000. The sample introduction tube 1000 has a sample introduction tip 222. A nebulizing gas 225 passes through the nebulizer tube 221 and mixes with the sample 1010 at sample introduction tip 222 to make a nebulized sample 226. The nebulizer may be a separate unit or an electrospray ionization (ESI) system. When the nebulizing gas 225 mixes with the sample 1010 at tip 222, the nebulizing gas 225 has a flow rate with a velocity of at least around 0.8 mach. In a preferred embodiment, the nebulizing gas has a velocity of at least around 1 mach. In this paragraph, around means plus or minus 10%.

While the conduit 210 is preferably attached to the top side of the heated vessel 200, the conduit 210 can be attached to any side of the heated vessel 200.

A heated auxiliary gas 230 is also introduced in the conduit 210 to surround the nebulizing gas and the nebulized sample 226. The heated auxiliary gas confines the nebulizing gas and the nebulized sample in a core region of the vessel. The ionization sources, for example the ESI 220 (acting as nebulizer as well) that is also placed in the conduit provide the ions which become confined in the central region of the vessel. The ESI can be operated in micro flow and nano flow modes.

The vessel 200 also has an exhaust port 240 that is preferably placed on the bottom side 202 of the of the vessel 200 and closer to the right side 204. The port is connected to a pump (not shown) to exhaust content of the vessel. While the exhaust port 240 is preferably placed on the bottom side 202 of the vessel 200, with the use of an appropriate pump the exhaust port 240 can be placed on any wall of the vessel 200.

The auxiliary gas 230, the nebulizing gas 225 and the curtain gas 206 and exhaust port 240 are configured to form a set of circulation flows, such as 1, 2, 3, 4 as in FIG. 1, inside the heated vessel 200 to contain the ions of nebulized samples in the core and central region of the heated vessel and away from the wall of the heated vessel 200. These gases are heated as is the vessel, thereby preventing condensation on the walls and formation of any contamination on the wall. In addition, the circulating flows continuously clean the surfaces to lessen any accumulation of any contaminant. The ions 229 in the vessel travel towards the exit orifice 205 and to the MS 290 under the influence of an electric field between the ionization region and the MS.

A heater 209 is used to heat the vessel to keep the gasses in the vessel at high temperatures, preferably above around 100° C. and less than around 1000° C., where around means plus or minus 10%. In a preferred embodiment, the vessel is heated to around 500° C., where around means plus or minus 10%. A person skilled in the art will know that these temperatures can be chosen to optimize the analysis being performed by the MS for the specific sample being analyzed. The auxiliary gas 230 can be heated before injection or can be heated inside the vessel. When the nebulizer is placed inside the conduit, the auxiliary gas is heated to generate a volatilization zone inside the conduit. When the tip of the nebulizer is inside the vessel, the volatilization occurs inside the vessel and the hot gases inside the vessel aid in volatizing the sample. The vessel 200 is sustained at high temperatures at all times preventing any cold region within the vessel, therefore, it will not allow any condensation to deposit on the walls of the vessel.

Different ionization systems can be used with this vessel. In one embodiment, an APCI 250 is placed on the left side, through an insulator 251, while an ESI 220 (also the nebulizer) is placed in the conduit with its tip placed inside the vessel. Temperatures and flow rates are adjusted for better desolvation and to prevent condensation. All residue gases and sample will be pumped out by waiting an appropriate period (generally, the exhaust pump is always operating) before the next sample introduction, preventing any cross contamination.

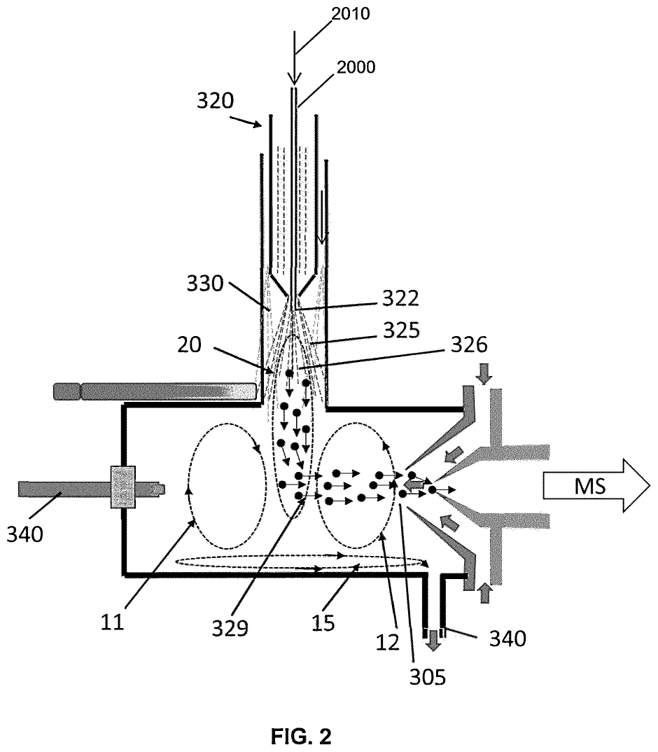

In another embodiment as shown in FIG. 2, an APPi 340 is placed on the left side. The ESI 320 with a nebulizing gas 325 is placed inside the conduit. The sample introduction tube 2000 and the sample introduction tip 322 are also inside the conduit. When the nebulizing gas 325 mixes with the sample 2010 at tip 322, the nebulizing gas 325 has a speed of at least around 0.8 mach. In a preferred embodiment, the nebulizing gas has a speed of at least around 1 mach. In this paragraph, around means plus or minus 10%.

A heated auxiliary gas 330 surrounds the ions 326 inside the conduit, wherein the volatilization occurring partly inside the conduit and the ions are confined in a central zone 20 of the vessel. The circulation zone 11 and 12, and the exhaust flow 15 generated by the pump connected to the exit port 340 confine the ion flow to region 20, while the electric field from the ionization zone to the MS forces guides the ions towards the orifice 305 and into the MS.

In the first embodiment of the present device as shown FIG. 1, nebulizer (or ESI) 220 and APCI 250 are placed in the vessel, whereas in a second embodiment as shown FIG. 2, a combination of APPi 340 and nebulizer (or ESI) 320 are used in one vessel. Nebulizer 320 is placed in the conduit. Sprayer plume 326 containing the sample is introduced inside the conduit. Nebulized samples are volatilized and are transported into the hot vessel by the aid of the nebulizer 325 and heated auxiliary gases 330. The geometry of the volatilization region, namely the length and diameter of the conduit, is configured to generate a laminar flow. Particles formed are entrained in the laminar flow and are transported into the hot vessel with high efficiency. APPi 340 requires volatilization before ionization. The temperature can be adjusted to optimize ionization (from the point of view of better MS detection) for better desolvation and to prevent condensation. This system allows for ESI and APPi to be accessible in one source, and therefore, there is no need for physical change to reconfigure the sample introduction system. This will allow for rapid and easy switching from one mode of ionization to another. Since both are placed inside the system, one can simply change from the ESI to the APPi application.

All residue gases and sample will be pumped out by waiting an appropriate period (generally, the exhaust pump is always operating) before the next sample introduction, preventing any cross contamination.

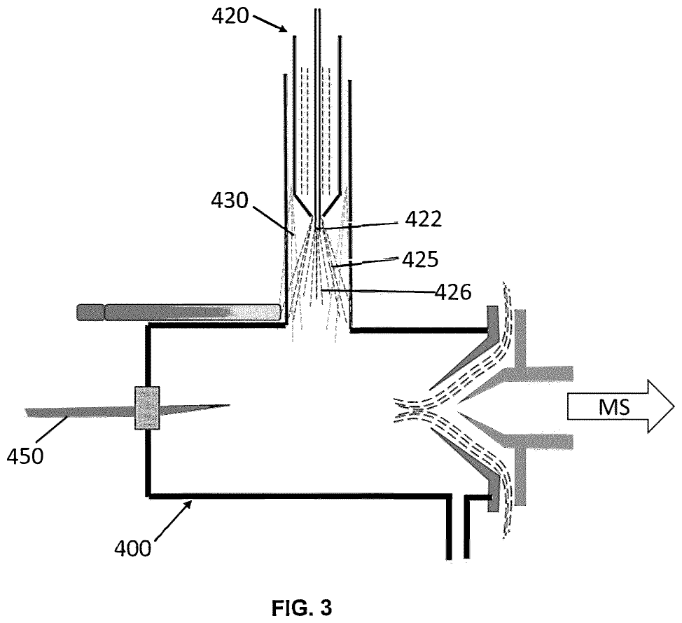

In the third embodiment as shown in FIG. 3, a combination of ESI 420 and APCI 450 are used in one source. ESI 420 is placed inside the conduit with its tip generating nebulized sample inside the conduit. The nebulized sample goes through the volatilization inside the conduit. An APCI 450 is placed on the left side of the vessel. Ionized species from ESI 420 proceed in this region and introduced into the vessel. Temperature is adjusted for better desolvation and to prevent condensation. This will allow for ESI and APCI to be accessible in one source. All residue gases and sample will be pumped out by waiting an appropriate period (generally, the exhaust pump is always operating) before the next sample introduction, preventing any cross contamination.

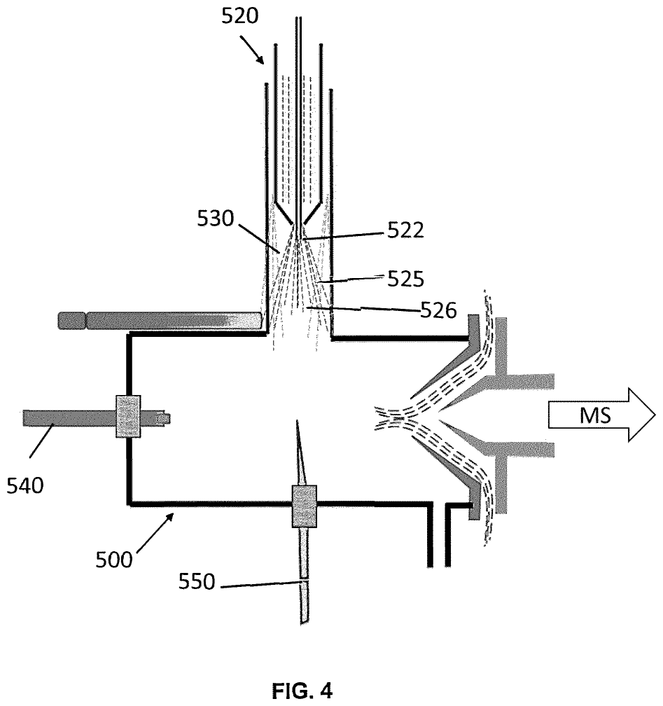

In the fourth embodiment as shown in FIG. 4, a combination of ESI 520, APCI 550 and APPi 540 are used in one vessel, and one can switch operation of the system from one to the other without any cross contamination (assuming proper pumping out of all residue gases and sample will be pumped out by waiting an appropriate period before the next sample introduction, preventing any cross contamination).

Sprayer plume 526, containing the sample, sprays into the volatilization region. ESI ions are transported into the hot vessel by flow of nebulizer gas 525 and auxiliary gas 530.

A person skilled in the art will know that these approaches can be used with any ionization devices that operate in an atmospheric environment.

In all embodiments, electric fields inside the vessel can be formed to direct the ions towards the sampling orifice. For example, in the case of ESI ions, the corona discharge needle can be used by applying appropriate voltage to form an electric field assisting ions to migrate towards the sampler. Formation of three-dimensional or more fields within the vessel allows ions generated from any mode of ionization, ESI, APCI, APPi or any other means of ionization in atmosphere, to be bunched and directed towards the sampling orifice for better sensitivity of the MS device regardless of the ionization mode.

1. A deposit-reducing system for mass spectrometry, comprising:
a heated vessel, to be mounted in front of a sample introduction system of a mass spectrometer (MS);
a heater configured to heat the heated vessel;
a conduit attached to the heated vessel;
a nebulizer configured to introduce a nebulizing gas, where the nebulizing gas has a nebulizer gas flow rate and temperature;
a sample introduction device having a sample introduction tip, configured to introduce a sample into the heated vessel through the sample introduction tip, wherein the sample introduction tip is placed either inside the conduit or inside the heated vessel;
the nebulizer and the sample introduction device being configured so the nebulizing gas mixes with the sample at the sample introduction tip to form a mixture of nebulizer gas and the sample at the sample introduction tip;
where the nebulizer gas flow rate is at least around 0.8+/−10% mach.

2. The deposit-reducing system for mass spectrometry of claim 1, further comprising:
a heated auxiliary gas, having an auxiliary gas flow rate and temperature, introduced into the heated vessel through the conduit and configured to surround the nebulizing gas;
a curtain cone, interfacing with the sample introduction system of the MS through an orifice of the sample introduction system of the MS, the curtain cone being located in the heated vessel;
a heated curtain gas, having a curtain gas flow rate and temperature, introduced between the curtain cone and the orifice;
the heated vessel having an exhaust port, the exhaust port being connected to a pump and the pump being configured to form an exhaust flow, having an exhaust flow rate, out of the heated vessel;
a first ionization device configured to ionize the sample and form a mixture of nebulizing gas and ions;
wherein the nebulizer gas flow rate and temperature, the auxiliary flow rate and temperature, the curtain gas flow rate and temperature, and the exhaust flow rate are configured to direct the ions away from the walls of the heated vessel.

3. The deposit-reducing system for mass spectrometry of claim 1, where the nebulizer gas flow rate is around 1.0+/−10% mach or higher.

4. The deposit-reducing system for mass spectrometry of claim 2, further comprising:
the tip of the sample introduction device having a voltage;
the curtain cone having a voltage lower than the tip; and
the orifice having a voltage lower than the curtain cone.

5. The deposit-reducing system for mass spectrometry of claim 2, further comprising:
the orifice having a voltage;
the curtain cone having a voltage lower than the orifice; and
the tip of the sample introduction device having a voltage lower than the curtain cone.

6. The deposit-reducing system for mass-spectrometry of claim 3, further comprising the tip of the sample introduction device, the curtain cone, and the orifice having voltages to form a voltage gradient, where the system is configured to allow an operator to switch between a positive voltage gradient and a negative voltage gradient.

7. The deposit-reducing system for mass spectrometry of claim 6, where the first ionization device is one of: (i) an electrospray device, (ii) an atmospheric pressure chemical ionization (APCI) device, or (iii) an atmospheric pressure photoionization (APPI) device.

8. The deposit-reducing system for mass spectrometry of claim 7, where the auxiliary gas and mixture of nebulizing gas and ions move in a laminar flow.

9. The deposit-reducing system for mass spectrometry of claim 8, wherein the heated vessel is heated up to at least around 500+/−10% ° C.

10. The deposit-reducing system for mass spectrometry of claim 5, wherein the heated vessel is tubular and the heated vessel has a cross-sectional shape selected from the group consisting of a circle, ellipse, oval and multisided shapes.

11. The deposit-reducing system for mass spectrometry of claim 10, wherein the heated vessel has a circular cross-sectional shape and has a diameter of around 45+/−10% mm and a length of around 75+/−10% mm.

12. The deposit-reducing system for mass spectrometry of claim 10, wherein the heated vessel has dimensions that fit within an envelope of dimensions of around 50+/−10% mm by around 50+/−10% mm by around 80+/−10% mm.

13. The deposit-reducing system for mass spectrometer of claim 11, further comprising a second ionization device, and the first ionization device and the second ionization device are configured to operate either simultaneously or as alternatives within the heated vessel.
